(19) United States
(12) Patent Application Publication
(10) Pub. No.: US 2025/0346520 A1
(43) Pub. Date: Nov. 13, 2025

(54) GLASS SCORING APPARATUS AND METHOD

(71) Applicant: CORNING INCORPORATED, CORNING, NY (US)

(72) Inventors: Benjamin Logan Carl, Corning, NY (US); Nils Paul Fornell, Harrodsburg, KY (US)

(21) Appl. No.: 18/863,507

(22) PCT Filed: Jun. 7, 2023
(86) PCT No.: PCT/US2023/024638

§ 371 Date: Nov. 6, 2024

Related U.S. Application Data
(60) Provisional application No. 63/350,494, filed on Jun. 9, 2022.

(51) Int. Cl. C03B 33/033

(52) U.S. Cl. CPC C03B 33/033

(57) ABSTRACT

A glass ribbon scoring apparatus and method includes a score head, a pressure regulator configured to exert a biasing force against the score head, a first pivot mechanism positioned between the score head and the pressure regulator, a second pivot mechanism mounted on a support member, and a lever arm positioned between the first pivot mechanism and the second pivot mechanism. The first and second pivot mechanisms rotate and the lever arm moves with movement of the score head.

### CROSS-REFERENCE TO RELATED APPLICATIONS

This application claims the benefit of priority under 35 U.S.C. § 119 of U.S. Provisional Application Ser. No. 63/350,494 filed on Jun. 9, 2022, the content of which is relied upon and incorporated herein by reference in its entirety.

### FIELD

The present disclosure relates generally to a glass scoring apparatus and method and more particularly to a glass scoring apparatus and method that enables more consistent score depth.

### BACKGROUND

In the production of glass articles, such as glass sheets for display applications, including televisions and hand-held devices, such as telephones and tablets, a glass ribbon can be flowed from a forming device. As the glass ribbon is flowed from the forming device, it can be conveyed for further processing into individual glass articles or sheets, which processing can involve scoring the ribbon in order to facilitate separation of the articles or sheets. As glass ribbons become thinner and/or wider, variations in ribbon thickness relative to total ribbon thickness may increase as a function of time and/or location. Such variations can, in turn, increase the importance of achieving a consistent score depth as inconsistent score depths can result in undesirable sheet (e.g., sheet edge) quality and/or process upsets. Accordingly, methods and apparatuses that enable more consistent score depth are desired.

### SUMMARY

Embodiments disclosed herein include an apparatus for scoring a glass ribbon. The apparatus includes a score head, a pressure regulator configured to exert a biasing force against the score head, a first pivot mechanism positioned between the score head and the pressure regulator, a second pivot mechanism mounted on a support member, and a lever arm positioned between the first pivot mechanism and the second pivot mechanism. The first and second pivot mechanisms are configured to rotate and the lever arm is configured to move with movement of the score head.

Embodiments disclosed herein also include a method of scoring a glass ribbon. The method includes moving a score head across a region extending along a width of the glass ribbon. The method also includes exerting a biasing force against the score head using a pressure regulator. In addition, the method includes rotating a first pivot mechanism positioned between the score head and the pressure regulator. The method also includes rotating a second pivot mechanism mounted on a support member. In addition, the method includes moving a lever arm positioned between the first pivot mechanism and the second pivot mechanism.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an example fusion down draw glass-making apparatus and process;

FIG. 2 is a side schematic perspective view of an example glass manufacturing apparatus and process;

FIG. 3 is a schematic cutaway view of a portion of a scored glass ribbon;

FIG. 4 is a schematic cutaway view of a portion of a scored glass ribbon;

FIG. 5 is a side schematic perspective view of an example scoring apparatus in accordance with embodiments disclosed herein;

FIG. 6 is a side schematic perspective view of a portion of the example scoring apparatus of FIG. 5;

FIG. 7 is a schematic cutaway view of a portion of a scored glass ribbon in accordance with embodiments disclosed herein;

FIG. 8 is a schematic cutaway view of a portion of a scored glass ribbon in accordance with embodiments disclosed herein;

FIG. 9 is a schematic cutaway view of a portion of a scored glass ribbon in accordance with embodiments disclosed herein; and

FIG. 10 is a schematic cutaway view of a portion of a scored glass ribbon in accordance with embodiments disclosed herein.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “housing” refers to an enclosure in which a glass ribbon is formed, wherein as the glass ribbon travels through the housing, it generally cools from a relatively higher to relatively lower temperature. While embodiments disclosed herein have been described with reference to a fusion down draw process, wherein a glass ribbon flows down through a housing in a generally vertical direction, such embodiments are also applicable to other glass forming processes, such as float processes, slot draw processes, up-draw processes, and press-rolling processes, wherein the glass ribbon may flow through the housing in a variety of directions, such as a generally vertical direction or a generally horizontal direction.

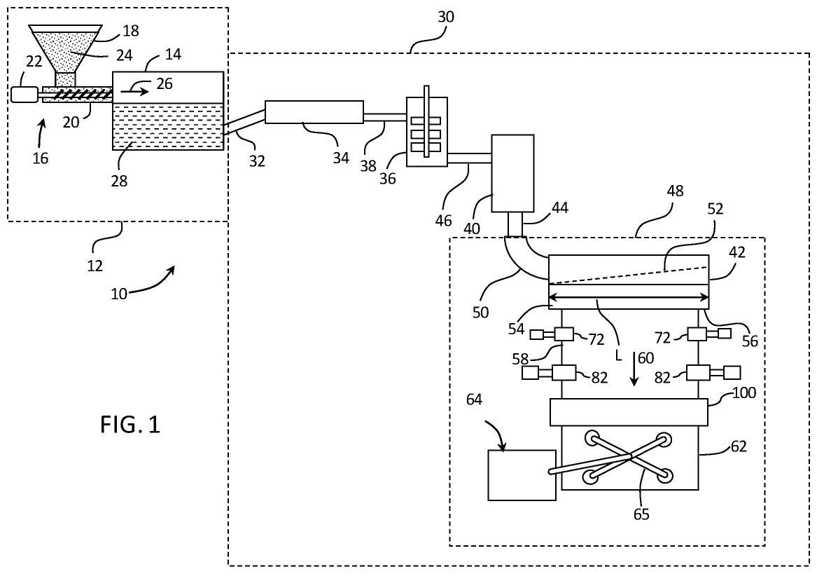

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. However, other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen produced by the temperature-induced chemical reduction of the fining agent(s) can diffuse or coalesce into bubbles produced in the molten glass during the melting process. The enlarged gas bubbles can then rise to a free surface of the molten glass in the fining vessel and thereafter be vented out of the fining vessel. The bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. While mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass-making apparatus can comprise a trough 52 positioned in an upper surface of the forming body 42 and converging forming surfaces 54 that converge in a draw direction along a bottom edge 56 of the forming body 42. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

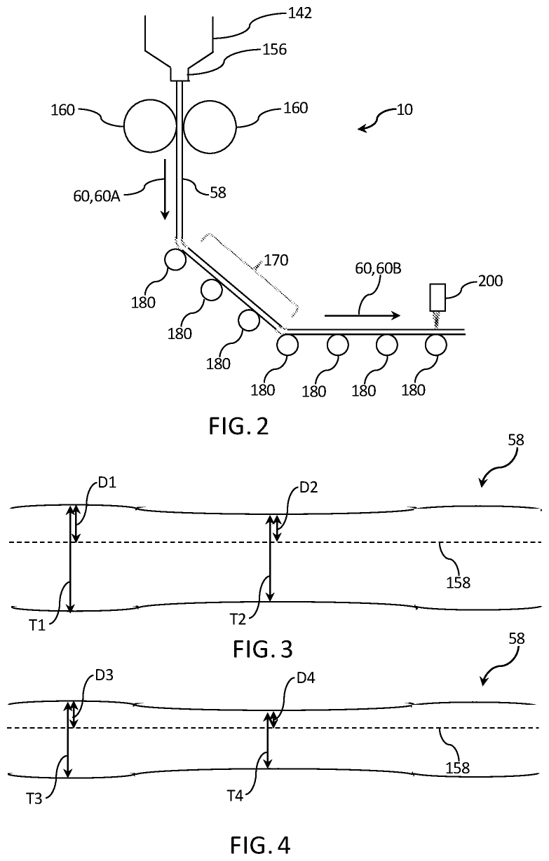

FIG. 2 shows a schematic perspective view of an example glass manufacturing apparatus 10 and process. Glass manufacturing apparatus 10 and process of FIG. 2 is similar to that of FIG. 1 except that in FIG. 2, the forming device comprises a forming vessel 142 comprising a slot 156 from which glass ribbon 58 flows in a draw direction 60. In addition, in FIG. 2, the glass manufacturing apparatus comprises a pair of opposing forming rolls 160 downstream of slot 156 which can be configured to contact opposing major surfaces of glass ribbon 58. Glass manufacturing apparatus 10 also comprises reorientation mechanism 170 configured to reorient the draw direction 60 from substantially vertical 60A (i.e., parallel to a gravity force vector) between the forming device (comprising forming vessel 142) and the reorientation mechanism 170 to substantially horizontal 60B downstream of the reorientation mechanism 170. As shown in FIG. 2, reorientation mechanism 170 comprises a plurality of rollers 180, each roller configured to contact edge regions of glass ribbon 58. Rollers 180 may also facilitate horizontal conveyance of glass ribbon 58 downstream of reorientation mechanism 170. During horizontal conveyance, glass ribbon 58 is scored by scoring apparatus 200 to facilitate separation of portions of glass ribbon 58 into individual glass sheets or articles.

FIG. 3 shows a schematic cutaway view of a portion of a scored glass ribbon 58. Glass ribbon 58 has a varying thickness along its width, wherein a first thickness T1 is greater than a second thickness T2. Score line 158 extends across a width of glass ribbon 58, wherein a first depth D1 of score line 158 at first thickness T1 is greater than a second depth D2 of score line 158 at second thickness T2.

FIG. 4 shows a schematic cutaway view of a portion of a scored glass ribbon 58. Glass ribbon 58 has a varying thickness along its width as well as a smaller average thickness than the glass ribbon shown in FIG. 3, wherein a third thickness T3 is greater than a fourth thickness T4. Score line 158 extends across a width of glass ribbon 58, wherein a third depth D3 of score line 158 at third thickness T3 is greater than a fourth depth D4 of score line 158 at fourth thickness T4. In addition, the third depth D3 of score line 158 at third thickness T3 is less than first depth D1 of score line 158 at first thickness T1 and fourth depth D4 of score line 158 at fourth thickness T4 is less than second depth D2 of score line 158 at second thickness T2.

The thickness variations of glass ribbon 158 shown in FIGS. 3 and 4 can, for example, be the result of inherent glass ribbon processing conditions that result in thickness variation in the widthwise direction and/or thickness variation over time (e.g., a larger or smaller average glass ribbon thickness as a function of time). Under such conditions, it may be undesirable for a score line depth to vary, such as the variations of score line depth shown in FIGS. 3 and 4.

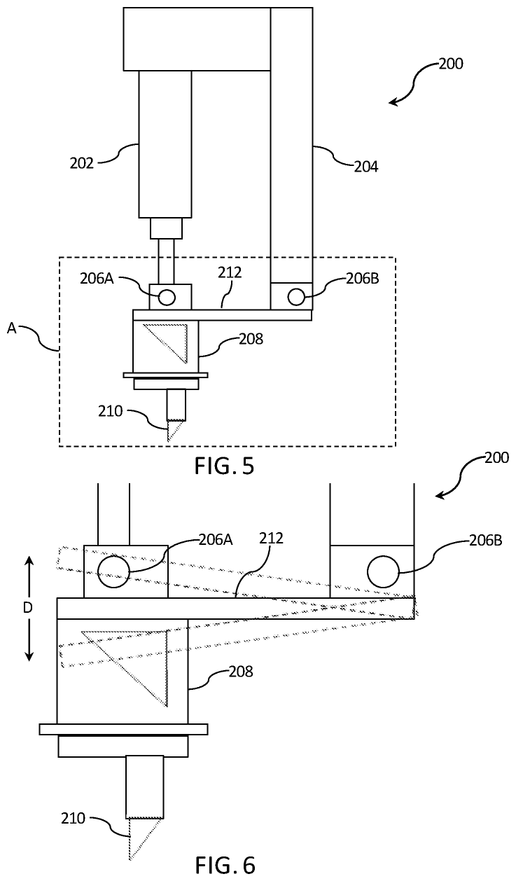

FIG. 5 shows a side schematic perspective view of an example scoring apparatus 200 in accordance with embodiments disclosed herein. Scoring apparatus 200 includes score head 210 and pressure regulator 202 configured to exert a biasing force against the score head 210. Scoring apparatus 200 also includes first pivot mechanism 206A positioned between the score head 210 and the pressure regulator 202 and second pivot mechanism 206B mounted on support member 204. A lever arm 212 is positioned between first pivot mechanism 206A and second pivot mechanism 206B and a counterweight 208 positioned between first pivot mechanism 206A and score head 210.

FIG. 6 shows a side schematic perspective view of a portion of the example scoring apparatus 200 of FIG. 5. Specifically, FIG. 6 shows a side schematic perspective view of the portion of scoring apparatus 200 shown in area A of FIG. 5. As shown in FIG. 6, lever arm 212 is movable between a neutral (i.e., horizontal) position and upward or downward pivot positions (indicated by dashed lines in FIG. 6) wherein an end of lever arm 212 closest to first pivot mechanism 206A moves vertically between neutral, upward, and downward pivot positions while end of lever arm 212 closest to second pivot mechanism 206B does not move vertically. Meanwhile, first pivot mechanism 206A moves vertically with vertical movement of lever arm 212 while second pivot mechanism 206B does not move vertically. Such vertical movement of lever arm 212 and first pivot mechanism 206A occur concurrently with vertical movement of score head 210, wherein maximum vertical movement of these components is shown by arrow D in FIG. 6. In addition, first pivot mechanism 206A and second pivot mechanism 206B rotate as the lever arm moves while score head 210 moves relative to pressure regulator 202.

In certain exemplary embodiments, a maximum distance of vertical movement (i.e., shown by arrow D in FIG. 6) of first pivot mechanism 206A and, hence, score head 210 relative to pressure regulator 202, ranges from about 1 millimeter to about 10 millimeters, such as from about 2 millimeters to about 8 millimeters, and further such as from about 3 millimeters to about 6 millimeters.

The biasing force exerted by pressure regulator 202 against score head 210 can be fixed or adjusted (either manually or via an automated mechanism) according to a target biasing force needed to impart a desired score depth across a width of a glass ribbon under a given set of processing conditions. While not limited to any particular range, in certain exemplary embodiments, biasing force ranges from about 1 psi to about 10 psi, such as from about 2 psi to about 8 psi, and further such as from about 3 psi to about 6 psi.

In certain exemplary embodiments, pressure regulator 202 comprises an electro-pneumatic regulator as known to persons having ordinary skill in the art, such as electro-pneumatic pressure regulators available from SMC Corporation of America.

In certain exemplary embodiments, first pivot mechanism 206A and second pivot mechanism 206B each comprise flex pivot bearings as known to persons having ordinary skill in the art, such as frictionless free-flex pivot bearings available from Flex Pivots.

Scoring apparatus 200 enables the generation of a score line in a glass ribbon, wherein the score line has minimal score depth variation across a width of the glass ribbon, including the generation of score lines with minimal depth variation across glass ribbons of varying thickness. Alternatively stated, scoring apparatus 200 can be configured to “float” on the surface of a glass ribbon while imparting a score line that mimics (or parallels) the surface topography of the glass ribbon.

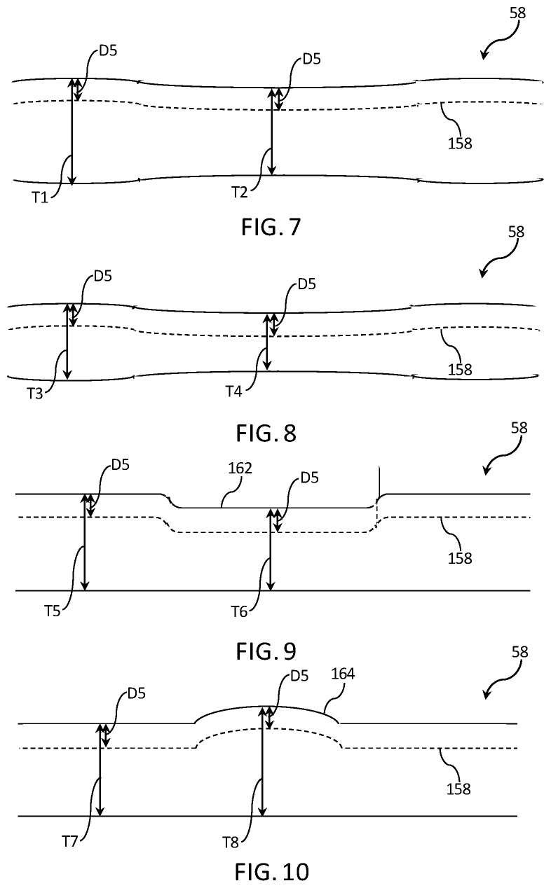

FIG. 7 shows a schematic cutaway view of a portion of a scored glass ribbon 58 in accordance with embodiments disclosed herein. Glass ribbon 58 has a similar cutaway profile as the glass ribbon shown in FIG. 3, such that it has a varying thickness along its width, wherein a first thickness T1 is greater than a second thickness T2. In contrast to FIG. 3, however, score line 158 is imparted on glass ribbon 58 using an exemplary scoring apparatus (e.g., scoring apparatus 200) in accordance with embodiments disclosed herein, wherein score line 158 parallels the topography of the surface of the glass ribbon 58 on which it is imparted such that a depth D5 of score line 158 at first thickness T1 is approximately the same as a depth D5 of score line 158 at second thickness T2.

FIG. 8 shows a schematic cutaway view of a portion of a scored glass ribbon 58 in accordance with embodiments disclosed herein. Glass ribbon 58 has a similar cutaway profile as the glass ribbon shown in FIG. 4 (i.e., smaller average thickness than glass ribbon 58 of FIG. 3), such that it has a varying thickness along its width, wherein a third thickness T3 is greater than a fourth thickness T4. In contrast to FIG. 4, however, score line 158 is imparted on glass ribbon 58 using an exemplary scoring apparatus (e.g., scoring apparatus 200) in accordance with embodiments disclosed herein, wherein score line 158 parallels the topography of the surface of the glass ribbon 58 on which it is imparted such that a depth D5 of score line 158 at third thickness T3 is approximately the same as a depth D5 of score line 158 at fourth thickness T4.

While thickness variations of glass ribbons 158 shown in FIGS. 3-4 and 7-8 can, for example, be the result of inherent glass ribbon processing conditions that result in thickness variation in the widthwise direction and/or thickness variation over time, glass ribbons 58 having specifically engineered or intentional thickness variations may also be scored in accordance with embodiments disclosed herein.

FIG. 9 shows a schematic cutaway view of a portion of a scored glass ribbon 58 in accordance with embodiments disclosed herein. Glass ribbon 58 has a varying thickness along its width, wherein glass ribbon 58 includes a thinned region 162 having a sixth thickness T6 than is less than a fifth thickness T5. Score line 158 is imparted on glass ribbon 58 using an exemplary scoring apparatus (e.g., scoring apparatus 200) in accordance with embodiments disclosed herein, wherein score line 158 parallels the topography of the surface of the glass ribbon 58 on which it is imparted such that a depth D5 of score line 158 at fifth thickness T5 is approximately the same as a depth D5 of score line 158 at sixth thickness T6.

FIG. 10 shows a schematic cutaway view of a portion of a scored glass ribbon 58 in accordance with embodiments disclosed herein. Glass ribbon 58 has a varying thickness along its width, wherein glass ribbon 58 includes a raised region 164 having an eighth thickness T8 than is greater than a seventh thickness T7. Score line 158 is imparted on glass ribbon 58 using an exemplary scoring apparatus (e.g., scoring apparatus 200) in accordance with embodiments disclosed herein, wherein score line 158 parallels the topography of the surface of the glass ribbon 58 on which it is imparted such that a depth D5 of score line 158 at seventh thickness T7 is approximately the same as a depth D5 of score line 158 at eighth thickness T8.

In certain exemplary embodiments, scoring apparatus 200 is configured to score a region extending along a width of glass ribbon 58, wherein the region has an average score depth (i.e., average score depth along the length of the score line) ranging from about 0.02 millimeters to about 1 millimeter, such as from about 0.05 millimeters to about 0.5 millimeters, and further such as from about 0.1 millimeters to about 0.2 millimeters. In certain exemplary embodiments, the score region has a score depth variation (i.e., the difference between the largest and smallest score depth along the score line) ranging from about 1 micron to about 25 microns, such as from about 2 microns to about 20 microns, and further such as from about 5 microns to about 15 microns. In certain exemplary embodiments, the score depth variation ranges from about 1% to about 25%, such as from about 2% to about 20%, and further such as from about 5% to about 15% of the average score depth.

In certain exemplary embodiments, glass ribbon 58 has an average thickness at or near the score region ranging from about 0.2 millimeters to about 10 millimeters, such as from about 0.5 millimeters to about 5 millimeters, and further such as from about 1 millimeter to about 3 millimeters. In certain exemplary embodiments, glass ribbon 58 has a temperature at or near the score region ranging from about 100° C. to about 900° C., such as from about 200° C. to about 800° C., and further such as from about 300° C. to about 700° C., and yet further such as from about 400° C. to about 600° C. In certain exemplary embodiments, scoring apparatus 200 is configured to score a region extending along a width of glass ribbon 58, wherein the region has an average score depth of from about 3% to about 15%, such as from about 5% to about 10% of an average thickness of glass ribbon 58 at or near the score region.

Embodiments disclosed herein include those in which glass ribbon 58 is conveyed in a horizontal direction (i.e., a direction perpendicular to the force direction of gravity) and the score depth extends in a vertical direction (i.e., a direction parallel to the force direction of gravity) at or near the score region.

Embodiments disclosed herein can enable the scoring of glass ribbons wherein, due to low weight, low friction, and high responsiveness of the scoring apparatus, the depth of the score line closely parallels the surface contour of a glass ribbon to provide consistent score depth in real time without a need for continuous monitoring and/or adjustment by an operator. Such can, in turn, enable the efficient production of glass articles, such as glass sheets, while minimizing undesirable events such as lateral cracking, hackle, shallow venting, chipping, and/or loss of contact between the score head and the glass ribbon.

While the above embodiments have been described with reference to fusion down draw and slot draw process, it is to be understood that such embodiments are also applicable to other glass forming processes, such as float processes, up-draw processes, and press-rolling processes.

Such processes can be used to make glass articles, which can be used, for example, in electronic devices as well as for other applications.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. An apparatus for scoring a glass ribbon comprising:
a score head;
a pressure regulator configured to exert a biasing force against the score head;
a first pivot mechanism positioned between the score head and the pressure regulator;
a second pivot mechanism mounted on a support member; and
a lever arm positioned between the first pivot mechanism and the second pivot mechanism;
wherein the first and second pivot mechanisms are configured to rotate and the lever arm is configured to move in conjunction with movement of the score head.

2. The apparatus of claim 1, wherein the pressure regulator comprises an electro-pneumatic regulator.

3. The apparatus of claim 1, wherein the first and second pivot mechanisms each comprise flex pivot bearings.

4. The apparatus of claim 1, wherein the score head is movable within a distance ranging from about 1 millimeter to about 10 millimeters.

5. The apparatus of claim 1, wherein the biasing force ranges from about 1 psi to about 10 psi.

6. The apparatus of claim 1, wherein the apparatus is configured to score a region extending along a width of the glass ribbon, the region having an average score depth ranging from about 0.02 millimeters to about 1 millimeter.

7. The apparatus of claim 6, wherein the region has a score depth variation ranging from about 1 micron to about 25 microns.

8. The apparatus of claim 6, wherein the glass ribbon is conveyed in a horizontal direction and the score depth extends in a vertical direction.

9. The apparatus of claim 1, wherein the glass ribbon has an average thickness ranging from about 0.2 millimeters to about 10 millimeters.

10. The apparatus of claim 1, wherein the glass ribbon has a temperature ranging from about 100° C. to about 900° C.

11. A method of scoring a glass ribbon comprising:
moving a score head across a region extending along a width of the glass ribbon;
exerting a biasing force against the score head using a pressure regulator;
rotating a first pivot mechanism positioned between the score head and the pressure regulator;
rotating a second pivot mechanism mounted on a support member; and
moving a lever arm positioned between the first pivot mechanism and the second pivot mechanism.

12. The method of claim 11, wherein the pressure regulator comprises an electro-pneumatic regulator.

13. The method of claim 11, wherein the first and second pivot mechanisms each comprise flex pivot bearings.

14. The method of claim 11, wherein the score head moves within a distance ranging from about 1 millimeter to about 10 millimeters.

15. The method of claim 11, wherein the biasing force ranges from about 1 psi to about 10 psi.

16. The method of claim 11, wherein the region has an average score depth ranging from about 0.02 millimeters to about 1 millimeter.

17. The method of claim 16, wherein the region has a score depth variation ranging from about 1 micron to about 25 microns.

18. The method of claim 16, wherein the glass ribbon is conveyed in a horizontal direction and the score depth extends in a vertical direction.

19. The method of claim 11, wherein the glass ribbon has an average thickness ranging from about 0.2 millimeters to about 10 millimeters.

20. The method of claim 11, wherein the glass ribbon has a temperature ranging from about 100° C. to about 900° C.

21. A glass article made by the method of claim 11.

22. An electronic device comprising the glass article of claim 21.
